(19) United States
(12) Patent Application Publication
(10) Pub. No.: US 2013/0316365 A1
(43) Pub. Date: Nov. 28, 2013

(54) Method of Preparing a Biological Sample for Inspection with Electron Microscopy and Fluorescent Light Microscopy

(71) Applicants: Elly van Donselaar, Utrecht (NL); Matthia Karreman, Utrecht (NL); Hans Gerritsen, Utrecht (NL); Theo Verrips, Utrecht (NL); Uwe Luecken, Eindhoven (NL)

(72) Inventors: Elly van Donselaar, Utrecht (NL); Matthia Karreman, Utrecht (NL); Hans Gerritsen, Utrecht (NL); Theo Verrips, Utrecht (NL); Uwe Luecken, Eindhoven (NL)

(73) Assignee: FEI Company, Hillsboro, OR (US)

(21) Appl. No.: 13/825,298

(22) PCT Filed: Sep. 21, 2011
(86) PCT No.: PCT/EP2011/066459

§ 371 Date: Aug. 12, 2013

Related U.S. Application Data
(60) Provisional application No. 61/384,715, filed on Sep. 21, 2010.

(51) Int. Cl. G01N 1/30

(52) U.S. Cl. CPC G01N 1/30
USPC 435/7.1; 435/309.1

(57) ABSTRACT

The invention relates to a method of forming sections for inspection in an electron microscope and a fluorescent light microscope. Conventionally these sections are made by for example the Tokuyama method, which involves freeze substitution and fixing at cryogenic temperatures. A problem is the time that it takes to come from a sample to sections, as the diffusion speed of the chemicals (organic solvents and fixatives) is extremely low. The invention comprises the sectioning of the sample at cryogenic temperature and fixing afterwards. As the sections are much thinner (e.g. 100 nm or less) than the sample (often >1 μm), the total time it takes to come from a sample to a section ready for inspection is less than 8 hours. This makes it possible to achieve results relevant for health care within one workday.

The invention relates to a method of preparing a biological sample for inspection in an electron microscope and a fluorescent light microscope, the method comprising:
Providing a biological sample,
Cryo-immobilizing a sample by high-pressure freezing,
Forming sections by cryo-sectioning,
Placing sections on a electron microscope grid,
Immuno-labeling at room temperature, and
Inspecting the sections with a electron microscope and a fluorescent light microscope,

Such a method is known from “Cryosection immunolabelling of difficult to preserve specimens: advantages of cryofixation, freeze-substitution and rehydration”, D. Ripper et al., Biol. Cell (2008), pp 109-123, further referred to a Ripper [1].

In a TEM a thin section of a sample is irradiated with an energetic beam of electrons. The section is sufficiently thin (typically less than 1 μm, more specifically less than 250 nm, most specifically less than 80 nm) that part of the electrons, typically with an energy of between 80 keV and 300 keV (although other energies are known to be used) pass through the section unhindered, part of the electrons are scattered and part of the electrons are absorbed, all due to interaction of the electrons with the atoms, more specifically the atomic nuclei, of the section. From these electrons that passed through the section an image is made on a camera, such as a CCD or CMOS camera, or for example on a phosphorescent screen.

It is noted that it is also known to scan the thin section with a finely focused beam, and to observe how many electrons pass through or reflect from the section. In this case the instrument is often referred to as a Scanning Transmission Electron Microscope. Most TEM's are capable to operate as a STEM and vice versa.

Biological samples typically are very low in contrast, as most of the material consists of atoms with both low and similar number of protons. Therefore it is common practice to label the section with heavy metals, such as uranium (by exposing the section to uranium acetate) and osmium (by exposing the section to osmium tetroxide), or by labeling the section with proteins to which electron dense material (for example silver or gold clusters) is attached. Each of these labels has its benefits in terms of specificity to tissue components, ease of use, etc. As an example: osmium tetroxide is known to ‘color’ lipids and thus to enhance the visibility of e.g. the lipid bi-layer of cells.

As mentioned before the TEM is capable to image thin sections. To make such a thin section the sample, such as a cell, a bacterium, or the like, must be immobilized and cut into sections of less than 1 μm, more specifically less than 250 nm, most specifically 80 nm. A well known manner of forming sections is by cutting the sample with a glass knife or a diamond knife. To make a successful cut the sample needs to be solidified, either by first freezing the sample, or by embedding the sample in plastic.

When freezing a sample the formation of ice crystals should be avoided, as these crystals result in ultrastructural changes of the morphology of the sample and ice needles may pierce or puncture the cell membranes. The formation of ice crystals can be avoided by for example high pressure freezing, in which a sample is first pressurized to a pressure of e.g. 2100 bar and then rapidly (cooling rate in excess of 10⁴ K/s) cooled by e.g. jet freezing with a jet of liquid nitrogen. An overview of high-pressure freezing is given in, for example, “Practical Methods in High-Pressure Freezing, Freeze-Substitution, Embedding and Immunocytochemistry for Electron Microscopy”, M. K. Morphew, Laboratory for 3-D Fine Structure, Dept. of MCD Biology, University of Colorado, Boulder, Colo., further referred to as Morphew [2], specifically the paragraph “A) Theory of freezing” at page 5. The sample is then called a vitrified sample and comprises so-called amorphous ice, and will, when properly handled, not show ice crystals. However, heating of the amorphous ice induces crystallization of the ice to one of its many crystal forms.

Ripper [1] describes a method for forming sections in her publication in paragraph “protocol for cryofixation-FS combined with thawed cryosection labeling”, page 112. She describes a method in which a sample is first cryo-fixed by high-pressure freezing, freeze-substituted in acetone containing 0.1% osmium tetroxide, 0.1-0.2% uranyl acetaat and 0.5% glutaraldehyde, as well as 0.5-1% methanol and 2-4% water.

It is noted It is noted that staining for electron microscopy is commonly done with e.g. uranyl acetate or osmium tetroxide as an electron dense marker or stain, but that these chemicals also act as a fixative. Fixatives are used to cross-link biological molecules (proteins, lipid bi-layers, etc.) so that these are not for example removed in later processing. A well-known fixative is glutaraldehyde.

After completing the freeze substitution, the sample was washes to remove fixatives at a temperature of −35° C. in acetone with 2-4% water and 0.5% glutaraldehyde. Then the samples were rehydrated at rising temperatures in the presence of 0.25% glutaraldehyde and were kept in water containing 0.25% glutaraldehyde for a further 30-90 minutes. After washing again in water, the samples were further processed for conventional Tokuyasu cryo-sectioning, sucrose/polyvinylpyrrolidone infiltration, freezing, cryo-sectioning and immune-labeling.

As known to the person skilled in the art, using the above mentioned method, the formation of sections takes days, typically 2 days or more. For example the dehydration of a sample at a cryogenic temperature takes days.

There is a need, especially for clinical diagnosis, in particular the early diagnosis of diseases, to have a method that shortens the time from (living) sample to electron microscope inspection, preferably to eight hours or less (one workday). It is noted that said long throughput time is a problem for a health care issue already for a long time, and that the incentive for finding shorter throughput times is a large incentive.

For clinical diagnosis, in particular the early diagnosis of diseases, it is also necessary to analyze rather large areas of the biological samples to find the relative low number of cells that are out of homeostasis. This is nearly impossible with electron microscopy. Therefore, combinations of fluorescent light microscopy to analyze large areas and electron microscopy to zoom in on suspected part of the sample has been developed. The fluorescent light microscope is used to detect and localize fluorescent dyes, thereby giving positional information of areas of interest.

Inventors further noted that samples prepared according to the Tokuyasu method cannot be analyzed to their satisfaction, as the heavy metals used to create the contrast necessary for electron microscopy quenches the fluorescence dyes used in the fluorescent light microscope.

The invention intends to provide a method for forming stained sections from biological samples with a shorter sample-to-inspection time.

The invention further intends to provide a method in which fluorescent dyes are not quenched.

To that end the method according to the invention is characterized in that fixation and/or staining are performed at cryogenic temperature on the sections mounted on the electron microscope grid.

The invention is based on the insight that by sectioning the sample at cryogenic temperature, subsequent processing takes place on section, thus decreasing infiltration time of chemicals and/or diffusion. For example, freeze substitution is performed in 85 minutes compared to two days in conventional methods.

Experiments show that with the method according to the invention it is possible to obtain sections for electron microscopy analysis in 8 hours or less, which is a crucial shortening of time in health care.

In an embodiment of the method according to the invention the fixation and/or staining is performed at a cryogenic temperature.

As unstained/non fixed sections are available at cryogenic temperatures of e.g. −150° C. it is possible to stain and/or fix the sections instead of the sample. The difference is that the sections are thin, while a sample is much thicker, and the time needed for staining/fixing of a section is thus much shorter than the time needed for staining/fixing a sample.

In a further embodiment of the method according to the invention the method further comprising freeze substitution of the sections, followed by bringing the sections from a cryogenic state to room temperature and a rehydration of the sections.

In this method, named VIS2FIX_{FS} by the inventors, with the FS referring to free substitution, the sections, attached to the grids, are exposed to freeze substitution, and heated. As there is no or almost no water present when heating from the cryogenic temperature to room temperature, no ice crystals are formed. Preferably the temperature at which the free substitution is performed is −90° C. or less to avoid crystal formation before the freeze substitution avoids further crystallization.

In a still further embodiment of the method according to the invention the freeze substitution comprises replacing water by a mixture of an organic solvent with fixatives, more specifically replacing water by a mixture of acetone and fixatives.

By replacing the water with an organic solvent, such as acetone, the sample can be heated to room temperature without ice crystals forming. Also the fixatives/stains can be dissolved in the organic solvent such as acetone.

In another embodiment of the method according to the invention the method comprises placing the frozen sections on a frozen water based fixative, followed by thawing and fixing the sections by melting the frozen water based fixative, and fixing the sections at a temperature of melting ice.

In this embodiment the sections are placed on frozen fixatives and then, together with the fixative, thawed. Experiments surprisingly showed that no ice crystals could be observed when processing a sample according to this embodiment.

In further embodiments the sections are labeled (at preferable room temperature) with fluorescent labels (to enable inspection/navigation using a fluorescent light microscope, with electron dense labels (such as labels comprising heavy metals from the group of gold, silver, palladium, platinum) for use as labels for the electron microscope, or with quantum dots, which are known to act as both fluorescent labels and labels for electron microscopy.

In a preferred method according to the invention the inspection of the sections is performed in an instrument that is a combination of an electron microscope and a fluorescent light microscope, also referred to as an iLEM (integrated light and electron microscope).

An aspect of the invention is characterized in that a handling device for performing the method comprises a container for holding frozen fixative and/or freeze substitution medium and/or a fluid for labeling, and a lid, the lid in working positioned on top of said container, the lid comprising a locking mechanism for detachable accepting grids.

The fixing and/or staining at cryogenic temperatures can be done in the handling device, as well as the placing on frozen fixatives followed by thawing. Also labeling may be done in this handling device.

Preferably the handling device is equipped to handle reinforced grids, that is: grids that are made more robust by equipping them with a thickened rim. Such grids are used for automated handling.

The invention is now elucidated using figures.

To this end:

FIG. 1 schematically shows a flow chart of the method(s) according to the invention,

FIG. 2 schematically shows a handling device for performing at least part of the method.

FIG. 3 shows ultrastructural aspects of VIS2FIX methods and immuno-gold labeling of PDI, and

FIG. 4 shows an iLEM image of VIS2FIXFS sections labeled for LAMP2.

FIG. 1 schematically shows a flowchart of the method(s) according to the invention.

As mentioned before the aim of the invention is to enable the analysis of a sample in such a way that, in spite of passing a critical temperature range for re-crystallization of water, damage of the samples is prevented. Moreover, the invention concerns with methods to fixate the biological samples in such a way that the heavy metals, necessary for good contrasts in electron microscopic images hardly quench the fluorescent dyes necessary for imaging with fluorescent light microscopy.

The inventors have invented two different, but closely related methods (called VIS2FIX, for vitreous section to/two fixatives) to solve the disadvantages of the presently used methods. Both methods are characterized by statical adherence of frozen sections to grids, followed by fixation of the sections in ways that avoid visible cryo-damage at ultra-structural level of the biological sample. Moreover, the invented methods allow for immuno-labeling of high pressure frozen material by section fixation resulting in a considerable reduction of quenching of fluorescent signals by heavy metals. Furthermore, the accessibility of the epitopes in the section is similar to that of Tokuyasu sections (Tokuyasu K T, J. Cell Biol. 1973, 51, 551-565, further referred to a Tokayasu [3]; Geuze H J et al. J. Cell Biol. 1981, 653-665, further referred to as Geuze [4]), increasing the chances of effective labeling. Due to the nature of the methods, the preparation time is much shorter than any described method until now and results can be obtained within a period of 8 hours.

Both routes of the invention start identical:

In step 101 a sample is provided, such as a biological sample in the form of a (part of a) cell, a bacterium, a biopsy, or such like.

In step 102 said sample is frozen by of high pressure freezing resulting in a vitrified sample showing no ice crystals. High pressure freezing is known per se to the skilled person.

In step 103 the high pressure frozen material is cryo-sectioned at a cryogenic temperature, for example a temperature of −150° C.

In step 104 the frozen sections are then adhered to a TEM grid, preferably statically with the help of for example the Leica CRION antistatic device.

Subsequently, the sections are transferred to the FS (Freeze substitution) chamber at a temperature of, for example, −90° C., preferably in an automatic freeze substitution unit, such as Leica AFS2 and are placed with the sections faced down on a fixative. The frozen sections are then fixed and warmed up to room temperature, preferably at a controlled temperature rate, and are ready for (conventional) immuno-labeling.

The fixation of the sections can be achieved in two ways; the VIS2FIX_{FS} and the VIS2FIX_{H} method.

The first section fixation method, VIS2FIX_{FS} (FS for Freeze Substitution), allows for the freeze substitution of the frozen sections.

In step 105 the water in the frozen section is replaced by an organic solvent, such as acetone, with fixatives. Since this is done at −90° C., there will no longer be water present in the section to form ice-crystals while the temperature is raised to 0° C. Freeze substitution is a commonly applied technique following high pressure freezing of biological material, but because in our method the volume is much smaller (the section is only 80 nm thick) it can be performed much quicker: in less than 85 minutes compared to at least 2 days in conventional methods. While the temperature is raised, the fixatives in the acetone start fixing the section so it is stabilized when it reaches 0° C.

In step 106 the sample can then be step-wise rehydrated from acetone to water and it is ready for:

Step 109 immuno-labeling and

Step 110: inspection with an electron microscope and a fluorescent light microscope.

With the VIS2FIX_{FS} method, one of the novel components lies in the possibility of performing a freeze substation on frozen sections, and the development of a shorter but effective freeze-substitution scheme. The user of this method can vary the length of the freeze substitution scheme and optimize it for different types of biological specimen and very important, vary the composition of the fixative mixture in the freeze substitution medium. We used 0.1-0.2% uranyl acetate throughout the freeze substitution (but to be removed during rehydration), and the presence of osmium tetraoxide and glutaraldehyde can be varied between a concentration of 0.1-0.5%. Furthermore, it is possible to remove the osmium at −60° C. from the freeze substitution medium to prevent any harmful effects on antigenicity caused by this fixative (the effect of osmium on antigenicity is only observed at temperatures above −60° C.).

The second section fixation method, VIS2FIX_{H} (H for hydrated), allows for chemically fixing the sections with fixatives in a hydrophilic environment (PHEM buffer) at 0° C.

In step 107, following step 104, at a temperature of −90° C., the frozen sections adhered to the grid are placed on frozen fixative.

In step 108 the fixatives and sections are then melted on a stove with a temperature of for example 40° C. until the surface of the fixative is liquid. Then, the sections are fixed for ten minutes on ice, protected from light. After this fixing period and washing steps, the sections are ready for

Step 109: immuno-labeling. Like with the VIS2FIXFS method, here it is possible and easy to vary in the composition of the fixative, depending on the user's requirements. One large advantage of this specific method is that the preservation of lipids in the section can be observed when osmium tetroxide is used in the fixative mixture. More conventional methods of TEM sample preparation either typically does not fix the lipids (e.g. the Tokuyasu [3] method described above) or cause the extraction of lipids before they can be fixed, like with freeze substitution. This makes this specific method of considerable interest for those who work in the lipidomics field. Since the sections are transferred from −150° C. to approximately 0° C. without cryo-protection or fixing beforehand, one would expect to see the ultrastructural effects of ice-crystal induced damage in the sections. The heterochromatin in the nucleus is one of the first and most affected structures in the cells by cryo-damage, but using the method as described above no damage was observed here, or in other parts of the cells. Our current explanation for this surprising and unexpected finding is that maybe, the ice-crystals formed were so small that it did not severely affect or damage the cellular structures. In step 110 the sections can then be inspected with a fluorescent light microscope, an electron microscope or a combined fluorescent light & electron microscope, also known as iLEM (integrated Light and Electron Microscope).

Required, or at least preferred, for both VIS2FIX methods is a high pressure frozen sample and/or a high pressure freezer, a cryo-microtome and cryo-sectioning related products, the Leica CRION antistatic device for adherence of the sections to the grids (or a similar apparatus or way to achieve this), an automatic freeze substitution unit (AFS) and accessories. At present, these pieces of equipment are not integrated and personal observation of processes and manual handlings have to be carried out. However, to the persons skilled in the art it will be clear that an integrated automated system starting with high pressure frozen sections up to the final fixation can be developed.

It is noted that instead of with a cryo-microtome the sample can also be cryo-sectioned with a Focused Ion Beam (FIB).

FIG. 2a schematically shows a cross-section of a handling device for performing the method according to the invention.

FIG. 2 shows a container (201) for holding frozen fixative and/or freeze substitution medium and/or a fluid for labeling, and a lid (202), the lid in working positioned on top of said container, the lid comprising a locking mechanism (203a+203b) for detachable accepting grids (209a+209b).

The lid has a first side on which one or more grids can be placed, preferably in indents (204a, 204b), although this is not required. At a cryogenic temperature the one or more grids on which the sections are deposited, are placed on the lid. The lid has provisions to hold the grid(s) in a detachable manner. In this example the provisions are depicted as a spring 203a that can be rotates and moved along axle 203b. In one rotational position the spring holds/latches the grids, in another rotation position the spring rests against the lid 202 and the grids are allowed to fall (when the indents are orientated downwards) or the grids can be loaded (when the indents are orientated upwards). It is noted that movement (detaching or loading the grids) can be eased by pressure differences through canals (not shown) blowing the grids from the indents or sucking them inwards.

The container can be filled with a fluid, such as freeze substitution medium or a fixative via inlet 205. The temperature of the container can be lowered to cryogenic temperatures by placing it in a cryogenic liquid (ethane, liquid nitrogen). It is noted that a container can be made comprising channels through which a cryogenic fluid can be circulated for this end.

The container comprises a series of indents 208a, 208b corresponding to the indents 204a and 204b. When these indents are filled with the fixative or freeze substitution medium and the temperature is adjusted to cryogenic temperature, as a result of which the indents 208a, 208b hold a freeze substitution medium at a cryogenic temperature or a frozen fixative, the lid is placed on the container and the grids are released from the lid. The grids then drop onto the freeze substitution or the frozen fixative.

The device is then heated in a controlled manner to room temperature. The controlling of the temperature can be achieved by an integrated heater 206, or by placing the handling device in a temperature controlled environment. Preferably the container comprises a temperature measuring device 207. The grids can be returned in the lid by flushing the grids against the lid and activating the locking mechanism 403a+403b. After reaching room temperature or a melting ice temperature the labeling can be done by adding labeling agent to the grid(s). This can be done in-situ in said handling device, but may be performed elsewhere (ex-situ).

The locking mechanism can act on a grid-to-grid basis, e.g. clamping or latching each individual grid, or can act on the complete number of grids.

FIG. 2b schematically shows a view of the lid as seen from the side that in working faces the container.

FIG. 2b schematically shows the lid 202 with eight indents 204-i. In one of the indents a grid 209 is placed, and the spring 203a is rotated by the axle 203b to a position where the spring holds the grid in the indent.

It is noted that, for better retaining the grid(s) in the indents, the end of the springs may have a better suited form, for example in the form of a loop, or that other such measures are taken for better and/or alternative holding mechanisms, obvious to the person skilled in the art. Also the movement of the mechanism can be based on different principles, such as mechanical actuators, magnetic actuation, piezo-electric actuation, etc.

The advantage of a handling device according to this aspect of the invention is that it can be part of an automatic handling station, or can comprise a controller and actuators to make it suited for automated sample handling. Preferably the device is then suited to handle robust grids with reinforced rim, such as described in U.S. Pat. No. 7,034,316.

As a (non-limiting) example of its use the inventors provide the following examples of the method according to the invention:

### Circulating Cells as Marker for (Early Stages of) Diseases, in Particular Cancer and Cardio Vascular Diseases

Circulating (blood) cells encounter all types of cells of other tissues in the body of humans and animals. During these encounters, exchange of “information” between the circulating cells and the “body” cells occur. This information exchange can be catalyzed by molecular signals send by the body cells, which molecules are recognized by receptor proteins on the circulating cells or that molecules or exosomes produced by the body cells are picked up by the circulating cells. Both processes result in changes in signaling processes in circulating cells and these signaling processes result in up- and down regulation of transcription of genes regulated by these signaling processes. Often these processes result in changes of the protein profile of the circulating cell. Moreover, (signal) molecule(s) can be picked up by the circulating cells and internalized (Hofman E, Thesis, Chapter 1, 2008, ISBN 978-90-393-4905) which processes also change the protein profile of the circulating cells. These changes in protein profile have often consequences on the morphology of the circulating cells and on cell surface antigens. Also, changes of protein complexes at the cell surface can occur, like dimerization and consequently activation or inactivation of extracellular receptors. Whereas changes in protein profile can be monitored by proteomic techniques, morphological changes can take place without noticeable differences in the protein profile, just as the formation of new complexes or the degradation of complexes in cells.

At present, it is possible to take small blood samples in a minimal invasive way. Small samples reflect more or less the biological processes that occur locally (at the spot and time of sampling). The amount of circulating cells thus collected is sufficient to provide statistical significant answers whether in the sampled area processes occur that predict deviations of certain cells from their homeostatic states. Until now, such samples are mainly investigated for proteins and cell counts but rarely when morphological changes or changes in protein complexes in circulating cells have occurred. The present inventions allow analysis of morphological changes as well changes in complexes in and on the surface of these cells.

### Experimental Results

### High Pressure Freezing, Sectioning and Grid Transfer to the AFS

THP-1 human monocytes from a leukemic cell line were purchased from ATCC (LGC Standards GmbH, Wesel, Germany) and cultured according to suppliers' instructions. For high pressure freezing, the cells were spun down (5 min 1200 rpm), and the pellet was resuspended in dextran (final concentration 15%). Copper specimen tubes were filled with the suspension of cells in dextran and high pressure frozen with the Leica EM PACT at a pressure of ˜2000 bar. The frozen tubes were stored in liquid nitrogen prior to sectioning. The tubes were trimmed and sectioned with diamond knives in the Leica EM UC6/FC6 ultramicrotome at a temperature of −150° C. with the Leica CRION antistatic device set to discharge. While sectioning, a ribbon of long glossy looking sections in the range of 60-80 nanometer in thickness was aligned above a TEM grid. The grid, with formvar film, carbon coated and glow discharged, was held in place close to the knife edge with the Leica micromanipulator. When the ribbon was sufficiently long, it was statically adhered to the grid with the Leica CRION antistatic device. Here, it was of great importance to check if the adherence was successful by trying to lift the section from the grid, which should not be possible. When using the VIS2FIXFS method, it was found that the sections should be at least 80 nm thick to achieve efficient fixation.

Following sectioning, the grid was placed in a Leica sapphire disc (SD) holder (part of the SD freeze substitution unit) which was present in the microtome chamber of the UC6, cooled down to −150° C. The SD holder can hold 24 sapphire discs or, for this application, grids. After sectioning the required amount of grids, the SD holder with grids was transferred from the microtome chamber to the FS chamber of the AFS2 (Leica automatic freeze substitution unit). Here, the grids must be kept cold and protected from humid air which can form ice crystals on the section. A pre-cooled tin (Leica Universal Container) was present in the microtome chamber with one cold ring (Leica bottom plate) on the bottom. The SD holder with the grids was placed in the tin, and covered with a donut-shaped aclar foil (Cut out from 200 μm Aclar embedding film, Electron Microscopy Sciences. The aclar foil's outer diameter is 3.5 cm. It has a hole in the centre, diameter 9 mm). Two more cold rings were placed on top and finally a disc-shaped aclar foil (diameter 3.5 cm). The tin was then quickly but carefully transferred to the AFS2, cooled to −90° C. The SD holder (placed in a closed petridish), the tin, the cold rings and the aclars were cooled down with the microtome before sectioning. A small piece of partially folded tape was stuck to face of the aclar foils and petridish lids, functioning as a handle to facilitate lifting and moving.

### VIS2FIXFS

In a Leica reagent bath (cut-off to minimize height to ±1 cm), a Leica flow-through ring (cut-off to minimize height to ±6 mm) was placed. The reagent bath with the flow-through ring was placed on top of three cold rings (Leica bottom plates) in a tin (Leica Universal Container) at −90° C. in the AFS2. At this temperature, 3 mL of pre-cooled to −90° C. dried acetone (Sigma-Aldrich, St Louis, Mo., United States) with fixatives was pipetted into the flow trough ring, and it was covered with a aclar foil (diameter 3.5 cm). Acetone was chosen as a FS medium since the retention of phospholipids in the sample is higher than with methanol. Fixatives used were 0.1% uranyl acetate, 0.1-0.5% glutaraldehyde and 0.2-0.5% osmium tetraoxide in acetone. Following sectioning, the grids in the SD holder were transferred to the FS chamber as described above. Using a pre-cooled bended fine tip forceps (similar to cover-slip forceps), each grid was carefully floated section side down on the surface of the fixative within one flow-through compartment of the ring. One flow-through ring holds a maximum of 10 grids, but up to three flow-through rings with fixative can be placed in the AFS2 as described above. Due to the low surface tension of the acetone, the grids eventually sink into the solution to the bottom of the flow-through compartments. As soon as the last grid was placed, the freeze substitution program was started. If desired, the fixative composition could be altered at any point during the freeze substitution. To achieve this, the majority of the fixative was removed from the centre of the flow-through ring, which could be followed up with some washing steps. Here, it is important to not let the grids fall dry. Subsequently, the new fixative could be added to the flow-through ring with the grids. Good morphology was achieved when the fixative from −90° C. to −60° C. was composed of 0.1% uranyl acetate and 0.2% osmium tetraoxide in Acetone, which subsequently was replaced for 0.1% uranyl acetate and 0.2% glutaraldehyde in Acetone. At the end of the freeze substitution program when the temperature reached 0° C., the grids were washed 5 or more times with 0.2% glutaraldehyde in dried acetone (approximately 3 mL per washing step) as described above. The following rehydration steps were performed in the AFS2 at 0° C., in 7 sequential steps of 1-2 minutes. 0.2% GA in 95% Acetone, 0.2% GA in 90% Acetone, 0.2% GA in 80% Acetone, 0.2% GA in 70% Acetone, 0.2% GA in 50% Acetone, 0.2% GA in 30% Acetone and finally 0.2% GA in 10% Acetone in water. After rehydration the grids in the flow-through ring were washed 3 times with water. The grids were removed from the flow-through ring with fine tip forceps, and the back of the grid was dried with slightly moist filter paper. Finally the grids were washed 7 times 1 minute while floating on drops of water placed on a strip of parafilm. At this point, the grids were ready for immuno labeling or storage for later use. These sections can be stored similar to Tokuyasu sections. For storage, the grids were shortly incubated on a drop of 1:1 mixture of methylcellulose and 2.3M sucrose in 0.1M PHEM buffer (composed of 60 mM PIPES, 25 mM HEPES, 10 mM EGTA and 2 mM MgCI, pH adjusted to 6.9) on ice. The grids were then gently pulled off the viscous drop and placed on a parafilm covered glass slide with the section and the drop facing downwards. The glass slide with the grids was placed in a glass petridish, sealed with parafilm, and was stored at 4° C.

### VIS2FIXH

Two mL fixative, containing 0.05-0.5% osmium tetraoxide, 0.2% uranyl acetate and 0.2% glutaraldehyde was prepared in 0.1M PHEM buffer, on ice. A final volume of 800 pL fixative was placed in the reagent bath (cut-off to minimize height to 1 cm) covering the bottom of the bath. The reagent bath was then transferred to the AFS2 (set at −90° C.) and placed on top of 3 cold rings in a tin, covered with an aclar foil (diameter 3.5 cm). The fixative immediately froze. The grids were transferred to the AFS2 as described above, and with pre-cooled fine tip forceps gently placed section facing down on the frozen fixative. The reagent bath with the grids was then placed in a cooled petridish to protect it from the air. It could then be taken out of the AFS2 and placed on a 40° C. hot plate, covered with a glass petridish (diameter 9 cm). While gently circling the petridish over the hot plate, the fixative melted. As soon as the surface of the fixative became liquid, which took typically 4-5 minutes, the grids started to float. The petridish with the fixative and grids was then quickly placed on ice, protected from light, and was allowed to fix for another 10 minutes. Finally, the grids were removed from the fixative and washed 10 times 1 minute on drops of water and were ready for immuno labeling or storage (as described above).

Immuno labeling for transmission electron microscopy (TEM) and integrated laser and electron microscopy (iLEM)

For immuno-TEM, the free aldehyde groups in the VIS2FIX fixed sections were quenched with 0.02M Glycine in 0.1M PHEM buffer by washing 5 times for 2 minutes. The sections were blocked from a-specific binding of the antibody by incubating for 15 minutes with blocking buffer, containing 1% (w/v) BSA (Bovine Serum Albumin) in 0.1M PHEM buffer, followed by 1 hour incubation with the primary antibody (mouse monoclonal anti PDI, 1:100, Stressgen Biotechnologies Corp., British Columbia, Canada) diluted in blocking buffer. After washing 5 times with 0.1% (w/v) BSA in 0.1M PHEM buffer, the sections were incubated for 20 minutes with a bridging antibody rabbit anti mouse lg (1:200 in blocking buffer, Dako, Glostrup, Denmark). The sections were washed 5 times 2 minutes on 0.1% BSA in 0.1M PHEM buffer, followed labeling with protein A gold (Cell Microscopy Centre, University Medical Centre Utrecht, 20 minutes incubation, in blocking buffer). After washing 10 times during 15 minutes on 0.1M PHEM buffer the labeling was stabilized by 5 minutes 1% glutaraldehyde incubation. To remove the buffer and the glutaraldehyde, the sections were washed 10 times for 1 minute on drops of water and stained for 5 minutes with 2% uranyl oxalate in water (pH 7). Thereafter, the sections were washed twice shortly on water. Finally, the sections were embedded in 0.4% uranyl acetate in 1.8% methyl cellulose on ice.

Correlative labeling for the iLEM was performed with a similar protocol. As a primary antibody Mouse monoclonal anti LAMP2 was used (1:150, BD Biosciences Pharmingen, San Diego, Calif., United States). Following the protein A gold incubation step, the grids were washed 5 times 2 minutes with 0.1% BSA in 0.1 M PHEM buffer followed by a 45 minutes incubation with Alexa 488 fluor conjugated goat anti rabbit antibody (1:200, Invitrogen, Carlsbad, Calif., United States). The sections were washed for 5 times 2 minutes with 0.1M PHEM buffer and fixed for 15 minutes with 4% formaldehyde (the usage of glutaraldehyde as a fixative could lead to an increase in auto fluorescence of the section). This was followed by 10 times 1 minutes washing on water and staining for 5 minutes with 2% uranyloxalate and then 2% uranylacetate. The sections were washed in between the staining steps twice shortly on water. Finally, the sections were washed and embedded in 1.8% methyl cellulose on ice.

### Imaging

The sections were imaged in the integrated laser and electron microscope (iLEM); a Tecnai 12 120 kV transmission electron microscope (FEI company, Eindhoven, The Netherlands). The iLEM has a custom designed laser scanning fluorescence microscope mounted on one of its side ports directly facing the sample stage. During TEM operation the fluorescence microscope is slightly retracted from the TEM column and does not interfere with TEM imaging or operation. The TEM images were recorded at 80 kV with a bottom mount TEMCam-F214 (Tietz Video and Image processing systems, Gauting, Germany) CCD camera. The laser scanning microscope is equipped with a 488 nm Bluephoton single mode laser (Omicron Laserage Laserprodukte GmbH, Rodgau-Dudenhofen, Germany) and an avalanche photo diode (APD) detector. The fluorescence microscope of the ILEM was operated using software custom designed by Dr. A. V. Agronskaia in LabView 8.0.

### Figure Legends for FIGS. 3 and 4

FIG. 3: Ultrastructural aspects of VIS2FIX methods and immuno-gold labeling of PDI. (a) The neutral lipids core of lipid droplets (LD) is lost after VIS2FIXFS fixation. (b) After VIS2FIXH the lipid core is observed as the density present inside the droplet. (c) Immuno-gold (15 nm) labeling of ER resident protein PDI on a VIS2FIXFS section. (d) Immuno-gold (10 nm) labeling of PDI on a VIS2FIXH section. Please note in both c) and d) the full cytoplasm and well preserved heterochromatin in the nucleus (N). Ly: lysosome; G: Golgi; M:Mitochondria; Mv: multivesicular body. Scale bars in a) and b) represent 300 nm, and 500 nm in c) and d).

FIG. 4: iLEM imaging of VIS2FIXFS sections labeled for LAMP2. (a) Fluorescence image of 50 μm² area on section labeled for LAMP2 with immuno-gold and immuno-fluorescence (see Online Methods). (b) Overlay of fluorescence signal of area indicated in a) with a white square on TEM image of the same region. (c) Higher magnification TEM image of the area indicated in b) with the black square. Note the excessive labeling of the lysosomes. Scale bars represent 10 μm in a), 1 μm in b), and 500 nm in c).

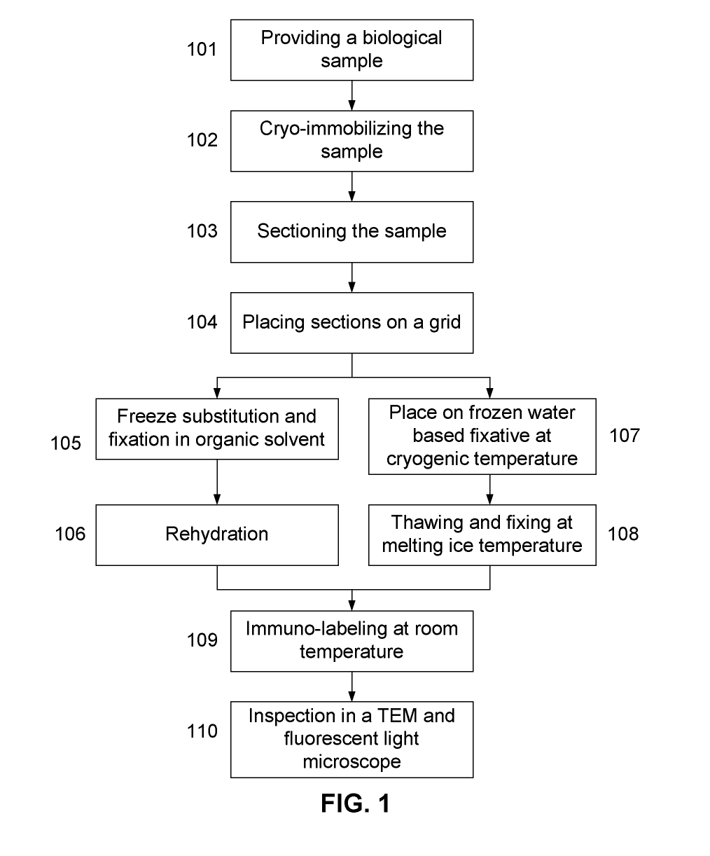

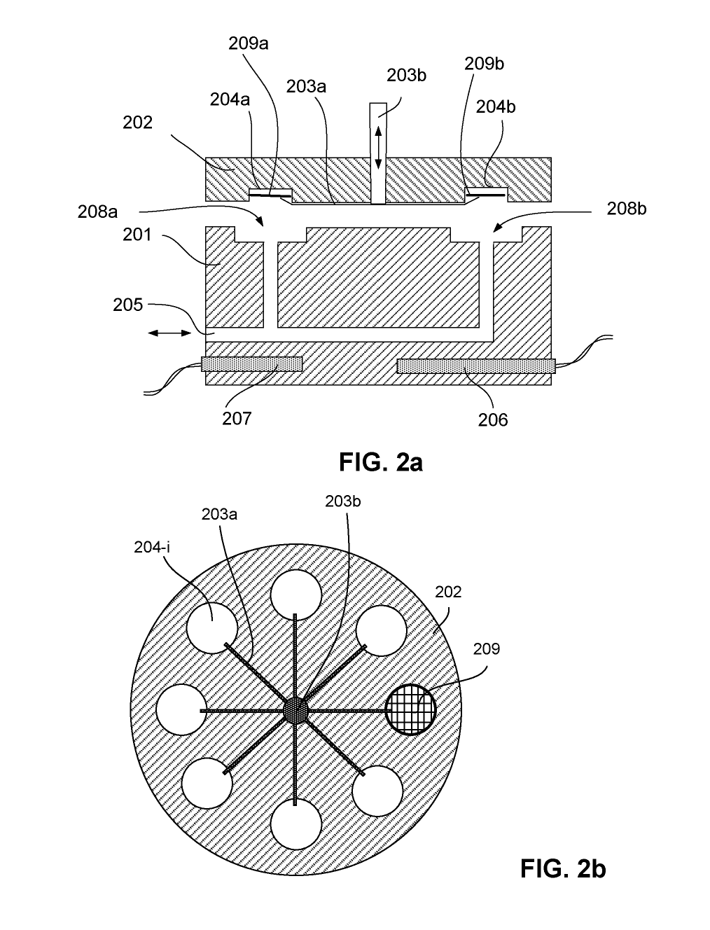

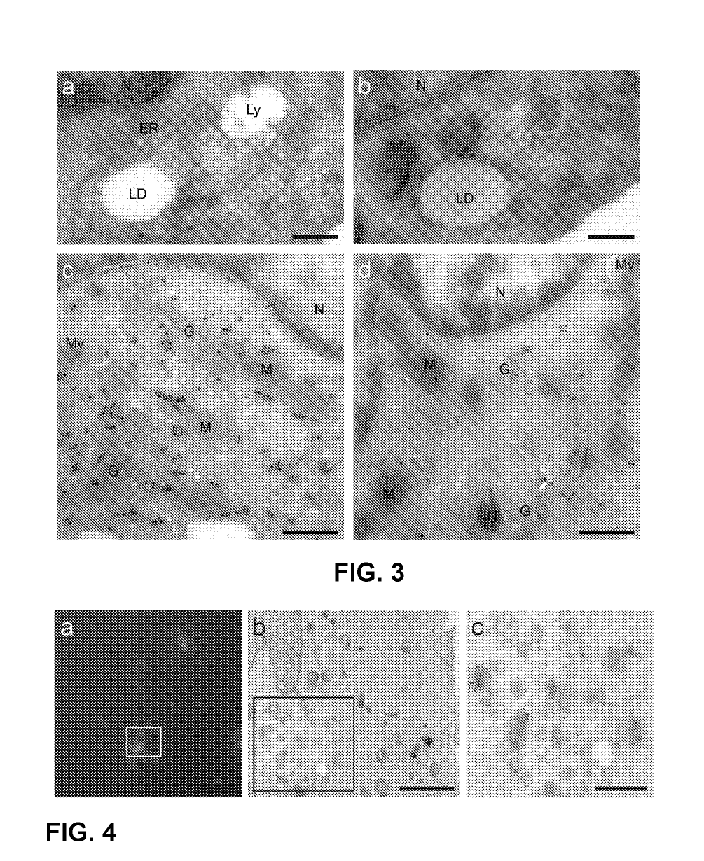

### Literature

[1] D. Ripper et al., “Cryosection immunolabelling of difficult to preserve specimens: advantages of cryofixation, freeze-substitution and rehydration”, Biol. Cell (2008) pp 109-123

[2] M. K. Morphew, “Practical Methods in High-Pressure Freezing, Freeze-Substitution, Embedding and Immunocytochemistry for Electron Microscopy”, Laboratory for 3-D Fine Structure, Dept. of MCD Biology, University of Colorado, Boulder, Colo.

[3] K. T. Tokuyasu, “A technique for ultracryotomy of cell suspensions and tissues”, J Cell Biol. 1973 May 1;57(2):551-565.

1. A method of preparing a biological sample for inspection in an electron microscope and a fluorescent light microscope, the method comprising:
providing a biological sample;
cryo-immobilizing a sample by high-pressure freezing;
forming sections by cryo-sectioning;
placing sections on an electron microscope grid;
immune-labeling at room temperature;
inspecting the sections with an electron microscope and a fluorescent light microscope; and
fixation and/or staining are performed on the sections mounted on the electron microscope grid.

2. The method of claim 1 in which the fixation and/or staining is performed at a cryogenic temperature.

3. The method of claim 2 further comprising:
freeze substitution of the sections;
bringing the sections from a cryogenic state to room temperature; and
rehydration.

4. The method of claim 3 in which the freeze substitution comprises replacing water by a mixture of an organic solvent with fixatives, more specifically replacing water by a mixture of acetone and fixatives.

5. The method of claim 4 in which the replacement is made at a cryogenic temperature, more specifically at a temperature of less than −90° C., most specifically at a temperature of −90° C.

6. The method of claim 1 in which the method further comprises;
placing the frozen sections on a frozen water based fixative;
thawing and fixing the sections by melting the frozen water based fixative; and
fixing the sections at a temperature of melting ice.

7. The method of claim 1 in which the labeling comprises labeling with fluorescent labels.

8. The method of claim 1 in which the labeling comprises labeling with electron dense labels, more specifically labels comprising heavy metals from the group of gold, silver, palladium, platinum

9. The method of claim 1 in which the labeling comprises the labeling with quantum-dots.

10. The method of claim 1 in which the electron microscope and the fluorescent light microscope are combined in one instrument.

11. The method of claim 1 in which an osmium comprising material is used as a fixative and/or an electron dense stain, and the osmium is removed from the freeze substitution medium at a temperature of −60° C. or less, thereby avoiding antigenicity.

12. A handling device comprising:
a container for holding frozen fixative and/or freeze substitution medium and/or a fluid for labeling,
a lid, the lid in working positioned on top of said container, the lid comprising a locking mechanism for detachable accepting grids.

13. The handling device of claim 12 equipped to handle grids with a reinforced rim, said grids suited for automated handling.

14. The method of claim 2 in which the fixation and/or staining is performed in the handling device according to claim 12.

15. The method of claim 6 in which the placing on the frozen water based fixative and the thawing takes place in the handling device according to claim 12.

16. The method of claim 2 in which the labeling takes place in the handling device according to claim 12.

17. The device of claim 12 in which the locking mechanism acts on each individual grid or on the complete number of grids.

18. The device of claim 12 further comprises a temperature measuring device and an integrated heater.

19. The method of claim 3 in which bringing the sections from a cryogenic state to room temperature takes place in the handling device according to claim 18.

20. The device of claim 12 further comprising an inlet and/or channels for circulating a cryogenic liquid.
